(19) United States
(12) Patent Application Publication
(10) Pub. No.: US 2026/0060162 A1
(43) Pub. Date: Mar. 5, 2026

(54) A plantable device for growing plant varieties, particularly a plantable case

(71) Applicant: IGREEN GADGETS S.R.I., Torino (IT)

(72) Inventor: Andrea Mullineris, Torino (IT)

(21) Appl. No.: 19/103,713

(22) PCT Filed: Sep. 1, 2023
(86) PCT No.: PCT/IB2023/058667

§ 371 Date: Feb. 13, 2025

(30) Foreign Application Priority Data
Sep. 2, 2022 (IT) 102022000018078

(51) Int. Cl. A01C 1/04; A45C 11/00; A45C 15/00; B29C 45/00; B29C 45/14; B29L 31/34

(52) U.S. Cl. CPC A01C 1/04; A45C 11/002; A45C 11/003; A45C 15/00; B29C 45/0053; B29C 45/14467; B29C 2045/0079; B29K 2995/006; B29L 2031/3481

(57) ABSTRACT

Disclosed herein is a plantable device for growing plant varieties, comprising a device body, a housing provided on the device body, a first plurality of seeds of one or more plant varieties, arranged in the housing, a water-soluble covering element arranged to cover said housing for retaining the plurality of seeds therein.

### FIELD OF THE INVENTION

The present invention refers to plantable devices for growing plants, specifically to devices configured for carrying seeds of plant varieties (e.g., plants and flowers) and for being inserted into the soil for growing the corresponding plant varieties. The invention was developed with particular reference to devices such as cases for electric or electronic devices, e.g., for mobile telephone devices.

### KNOWN ART

The growing trend towards reducing the impact of human activities on the environment has paved the way to intensive research in the field of the so-called “circular economy”, i.e., a chain of economic activities conceived as a circular evolution, wherein at least part of the intermediate or final products of the chain are re-used in a subsequent stage of the chain. One of the sectors of such research regards the conversion of the products which have ended their service life: some examples are the cases for mobile telephone devices (specifically the cases for smartphones or tablets), which are produced by the billions and often have a much shorter service life than the device which they protect, e.g., due to an early wear or simply due to the user's desires.

The post-consumption management of such products is all but easy. Recycling such products is very difficult, because they usually comprise different materials which are assembled permanently and which must be recycled in different ways (which is seldom possible), and which therefore have a very high impact on the environment.

In this regard, the Applicant has already filed an Italian Invention Patent Application (102021000019316) regarding a case for mobile telephone devices, which is made of a biodegradable and compostable material inside which there are dispersed seeds of one or more plant varieties. In the invention according to such Application, the seeds are dispersed within the material of the case, which acts as a matrix. The case is plantable in the soil, for example in a pot, and the dispensing of water promotes both the biodegradation/composting of the case material and the germination of the seeds embedded therein.

A substantially unsolvable problem which may appear in the use of such a technical solution regards the difference between the biodegradation/composting speed and the speed of seed germination. The latter speed, specifically, is much higher than the former, despite supplying the soil with water in order to accelerate the biodegradation of the case, whatever the biodegradable or compostable material of the case may be. Tests show that very few seeds, compared to the total number of seeds dispersed in the material of the case, achieve germination without being suffocated by the material itself. If, on one hand, this enables meeting the requirements as regards the environmental impact, on the other hand the goal fails of converting the case into a new usable good (e.g., a plant or ornamental flowers).

### OBJECT OF THE INVENTION

The present invention aims at solving the technical problems described in the foregoing. Specifically, the invention aims at providing a plantable device for growing plant varieties (specifically a plantable case) configured for carrying seeds for plant varieties, wherein the material of the plantable device does not hinder the germination of the seeds.

### SUMMARY OF THE INVENTION

The object of the invention is achieved by means of a plantable device having the features set forth in the claims that follow, which form an integral part of the technical disclosure provided herein in relation to the invention.

### BRIEF DESCRIPTION OF THE FIGURES

The invention will now be described with reference to the annexed Figures, which are provided by way of non-limiting example only, and wherein:

FIG. 1 is a perspective view, essentially from the back, of a plantable device according to the invention installed on a mobile telephone device,

FIG. 2 is an orthogonal view from the back of the plantable device according to the invention installed on a mobile telephone device; the Figure specifically shows an embodiment alternative to the embodiment of FIG. 1,

FIG. 3 is a perspective view, essentially from the front, of the plantable device according to the invention,

FIG. 4 is a perspective view, essentially from the back, of the device according to the invention corresponding to FIG. 2,

FIG. 5A and FIG. 5B respectively correspond to a perspective view in longitudinal section and to an orthogonal view in longitudinal section of the plantable device according to the invention,

FIG. 6A and FIG. 6B respectively correspond to a perspective view in cross section and to an orthogonal view in cross section of the plantable device according to the invention,

FIGS. 7 and 8 show two operating conditions of the plantable device according to the invention.

### DETAILED DESCRIPTION

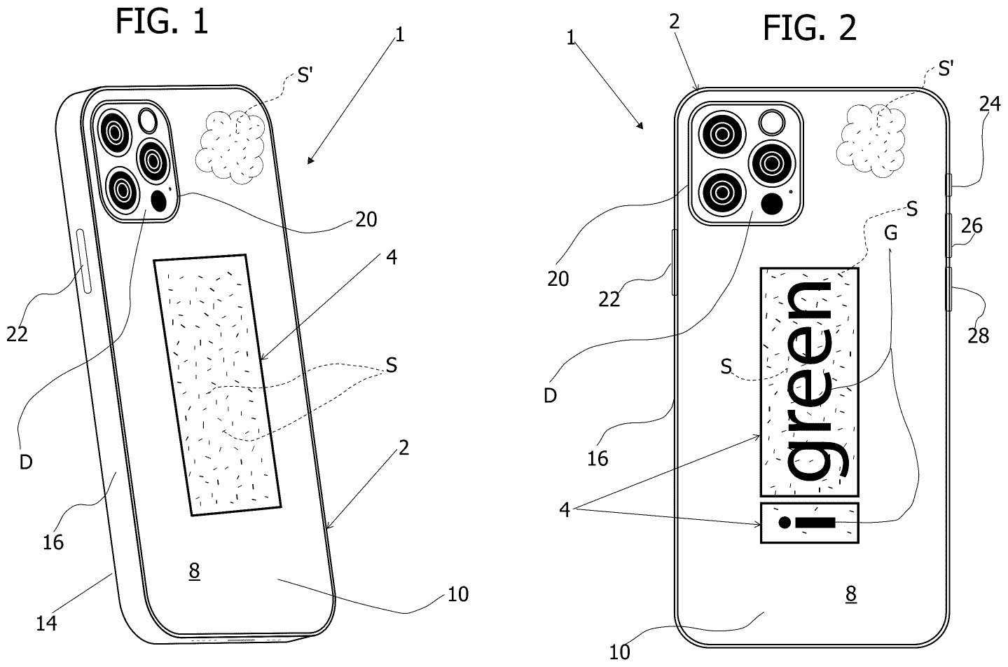

Reference number 1 in the FIGS. 1 to 8 generally denotes a plantable device for growing plant varieties according to a preferred embodiment of the invention. In various embodiments, including the embodiment in the Figures, the plantable device 1 comprises a device body 2, a housing 4 provided on the device body 2, a first plurality of seeds S of one or more plant varieties, arranged in the housing 4, and a water-soluble covering element 6 arranged to cover the housing 4 for retaining the plurality of seeds S therein.

The housing 4 may comprise, according to the embodiment, a housing recessed within the device body 2, as in the FIGS. 1 to 8, or it may simply consist in an area for arranging the seeds S, and therefore may be an area flush with the surrounding surface or even an area raised with respect to the surrounding surface. Moreover, specifically referring to FIGS. 1 and 2 (but this may be true for any embodiment of the invention), it is possible to provide a second plurality of seeds S′ of one or more plant varieties, embedded in the device body 2 outside the housing 4. In this respect, the Figures only show a partial representation of the dispersion of seeds S′ within the material of the device body 2 (shown in small clouds or in separated groups in the Figures in section), being it understood that the seeds of the plurality S′ may be dispersed throughout the body 2 or in selected areas thereof.

Advantageously, the device body 2 may be made of compostable material. Examples of compostable materials used for making the body 2 comprise:
the material known on the market as Ceroflex® FB 3416 produced by da FKuR Kunststoff GmbH, which is a “Biodegradable and home compostable polymer compound suitable for blown film applications. The biobased carbon content (BCC) is >60 % (calculated)”. Such a material is certified by TÜV Austria as “OK COMPOST HOME”;
the material known on the market as Bio-Flex® FX 1135 produced by FKuR Kunststoff GmbH, which is a “Soil degradable polymer compound suitable for blown film applications. Certified as soil biodegradable according to EN ISO 17556. Use in applications such as mulch film”.

Preferably, and again with general validity for all the embodiments of the invention, the water-soluble coating element 6 is implemented as a foil-like covering element, which is applied onto the housing 4 in order to cover the first plurality of seeds S, and onto at least part of the surface surrounding the housing 4, essentially in order to enlarge the fixing area thereof. Examples of materials which may be used for the coating element 6 include polyvinyl alcohol (PVA, PVOH or PVAL), particularly a polyvinyl alcohol film which is water-soluble. The water-soluble polyvinyl alcohol films do not resist in the environment, do not contaminate the waste recycling chain and do not produce microplastic pollution.

As known in itself, the polyvinyl alcohol films may be implemented in such a way as to be water-soluble at different temperatures, according to the selected application. For the purposes of the present invention, a preferred solution—which is however non-limiting—consists in the use of a polyvinyl alcohol film having a composition similar to what is used in the textile industry for embroidering images on clothing. An example of such a product comprises the material known on the market as Avalon Fix, produced by MADEIRA Garne U.+M. Schmidt & Co. GmbH.

Referring to the FIGS. 1 to 4, in the preferred embodiments of the invention the plantable device 1 is a plantable case for a mobile telephone device D or a mobile computer, in particular a smartphone D or a tablet. The Figures show a case for a smartphone D, being it obvious that a case for a tablet shares the general structure thereof, albeit having a different size and/or a different aspect.

The device body 2 of the case 1 comprises a back wall 8, including an outer surface 10 and an inner surface 12, and a side wall, including an outer surface 16 and an inner surface 18. The side wall 14 generally comprises a set of walls which are united without interruptions, the shape whereof is determined by the shape of the device to be housed in the case 1. In this regard, the side wall 14 projects from the back wall 8 in such a way as to define, with the respective inner surfaces 18, 12, an installation seat for the mobile telephone device D or the mobile computer. The device body 2 is preferably made of a compostable material, and in particular of one of the materials listed in the foregoing (Ceroflex® FB 3416 and Bio-Flex® FX 1135).

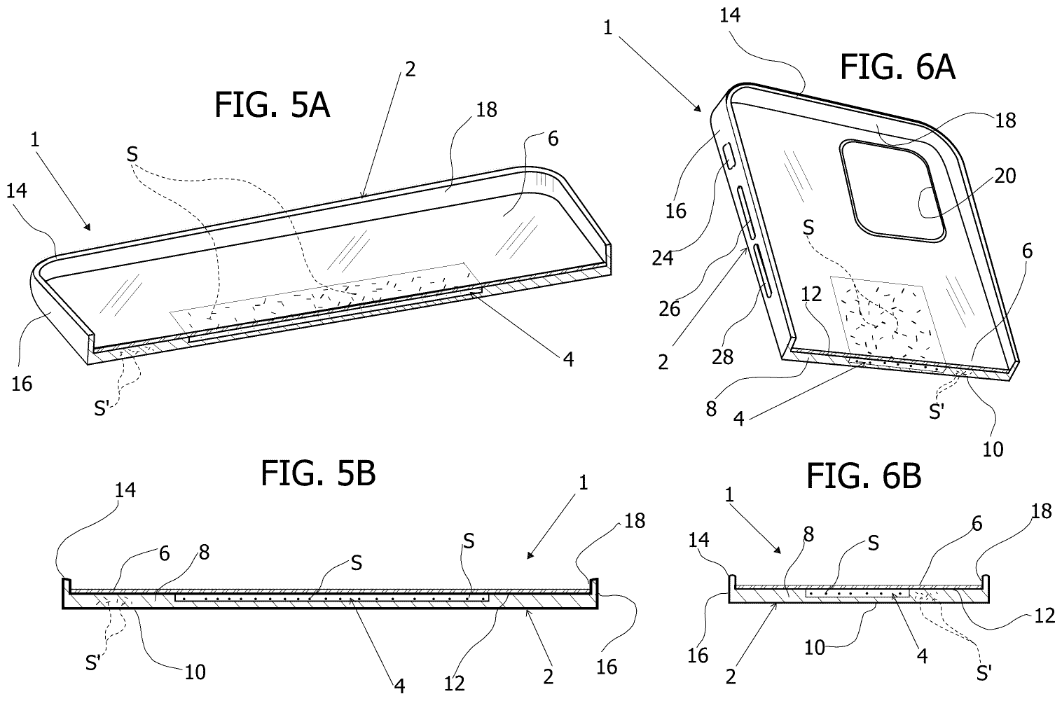

Referring to the FIGS. 5A, 5B and 6A, 6B, in the preferred embodiments of the case 1 the housing 4 is located in the back wall 8 and it is open at the inner surface 12 thereof. More specifically, the housing 4 is a compartment recessed within the thickness of the back wall 8 and open at the surface 12, but it extends only through a part of the thickness of the wall 8, therefore being blind. The seeds S of the first plurality are arranged within the housing 4 (i.e., within the recessed compartment) and are retained therein by means of the covering element 6.

Referring to the FIGS. 2 and 4, some alternative embodiments may envisage—while remaining identical in all other respects—one or more graphics G applied at the bottom of the housing 4. The graphics G may be substantially bidimensional (and therefore substantially flush) or may be three-dimensional, raised or recessed. In such cases, the seeds S are arranged primarily in the areas between the boundaries of the housing 4 (which, as described in the foregoing, is preferably a recessed compartment) and the graphic relief, or they may be arranged both in the housing 4 and in the further recess of the graphics G. Moreover, as shown in the FIGS. 2 and 4, it is possible to have a housing 4 divided into two parts, or anyway comprising a plurality of separated housing areas which comply with the features of the graphics G. Each housing area forming the housing 4 may be recessed with flush graphics G, recessed, or raised.

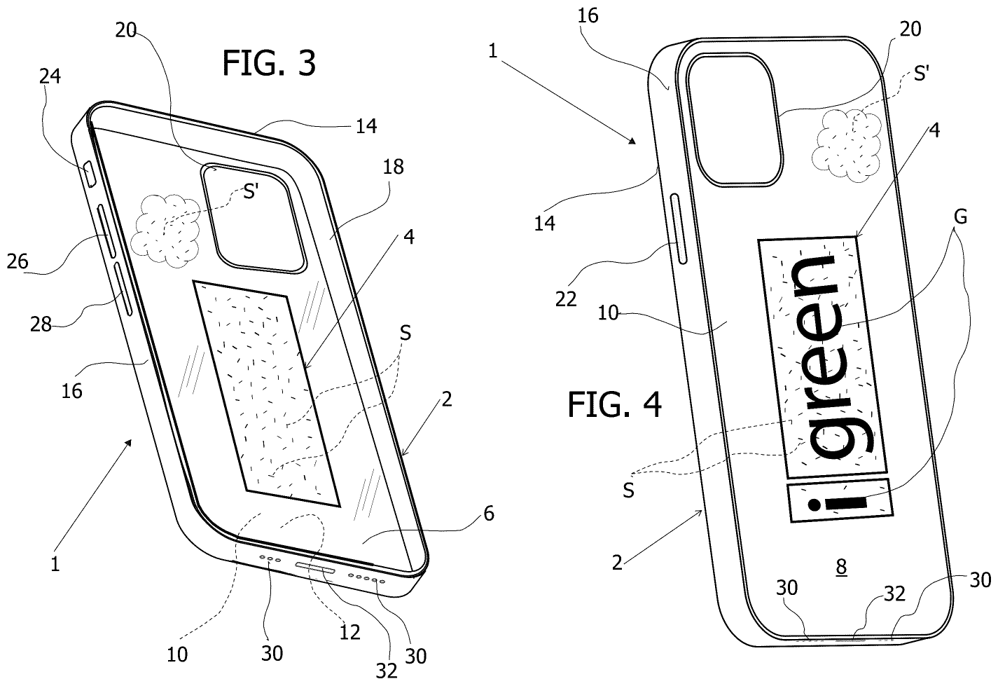

In the preferred embodiments of the invention shown in FIGS. 1 to 8, and specifically referring to the FIGS. 5A, 5B and 6A, 6B (and moreover to FIG. 3), the water-soluble covering element 6 is a foil-like covering element, which is applied at least on part of the inner surface 12 of the wall 8 so as to be located at the housing 4 and to cover the first plurality of seeds S. Preferably, the water-soluble foil-like element 6 extends to cover the whole surface 12, so as to maximize the fixing area on the surface. The foil-like covering element 6 may generally be transparent to visible light (but embodiments may be envisaged wherein the covering element 6 is opaque or not completely transparent) so as to enable catching a glimpse of the plurality of seeds S therethrough. The material of the device body 2, whether compostable or non-compostable, is preferably chosen to have an opacity lower than 100%, so as to enable catching a glimpse of the plurality of seeds S′, if they are present. Of course, while keeping in mind the limits due to the intrinsic properties of the selected material, it is possible to choose opacity values which do not enable to see the seeds S′ from the outside; in this case, such seeds are visible only if they emerge on the outer surface 10 and/or 16.

Referring again to all the FIGS. 1 to 6, the case 1 may moreover comprise—according to the features of device D—a through opening 20 on the back wall 8, so as to expose one or more imaging devices C (e.g., a set of back cameras) to the outside; one or more raised pads 22, 24, 26, 28 for the management of various controls of the device D, e.g. a screen lock key 22, a ringtone-off key 24 (optionally, instead of a pad there may be provided a through opening for a direct access to the key) and volume control keys 26, 28. Moreover, there may be provided through openings 30 for the diffusion of the sound of the loudspeakers of device D, and a through opening 32 for the access of a charging connector of the device D.

As regards the manufacture of the plantable device 1, specifically referring to the case 1, the invention defines a manufacturing method which comprises:
making the device body 2,
making said housing 4,
applying the first plurality of seeds S at said housing 4, and
applying the water-soluble covering element 6 to cover the housing 4, in order to retain the plurality of seeds S therein.

The housing 4 may be formed at the same time as the body 2, or it may be formed later, according to needs.

According to an advantageous aspect of the invention, manufacturing the device body 2 comprises providing a mould including a mould cavity, inserting the second plurality of seeds S′ into the mould cavity, and injecting a compostable material into the mould cavity, in order to form said device body 2, thereby incorporating the seeds of the first plurality into the device body 2. The same is true in the case of injecting a non-compostable material, and/or in the case of injecting material without incorporating the seeds S′. The essential element in the case of inserting the seeds S′ is the control of the temperature of the injected material, so as to avoid damaging the seeds irreparably. In this regard, the method envisages a thermal conditioning of the injection tools and/or the mould (e.g., by means of cooling channels in the die and/or in the punch), in such a way as to keep the temperature of the material entering the mould cavity at values equal to or lower than 90° C. (generally corresponding to a temperature of the mould cavity of about 130° C.-140° C.).

If the body 2 is manufactured by means of injection moulding, no matter what the material may be (whether compostable or not), it is preferable to form the housing 4 at the same time as the body 2, i.e., by forming a mould cavity which has a shape complementary to the shape of the housing 4 at the surface which will form the wall 8, specifically the surface 12 thereof.

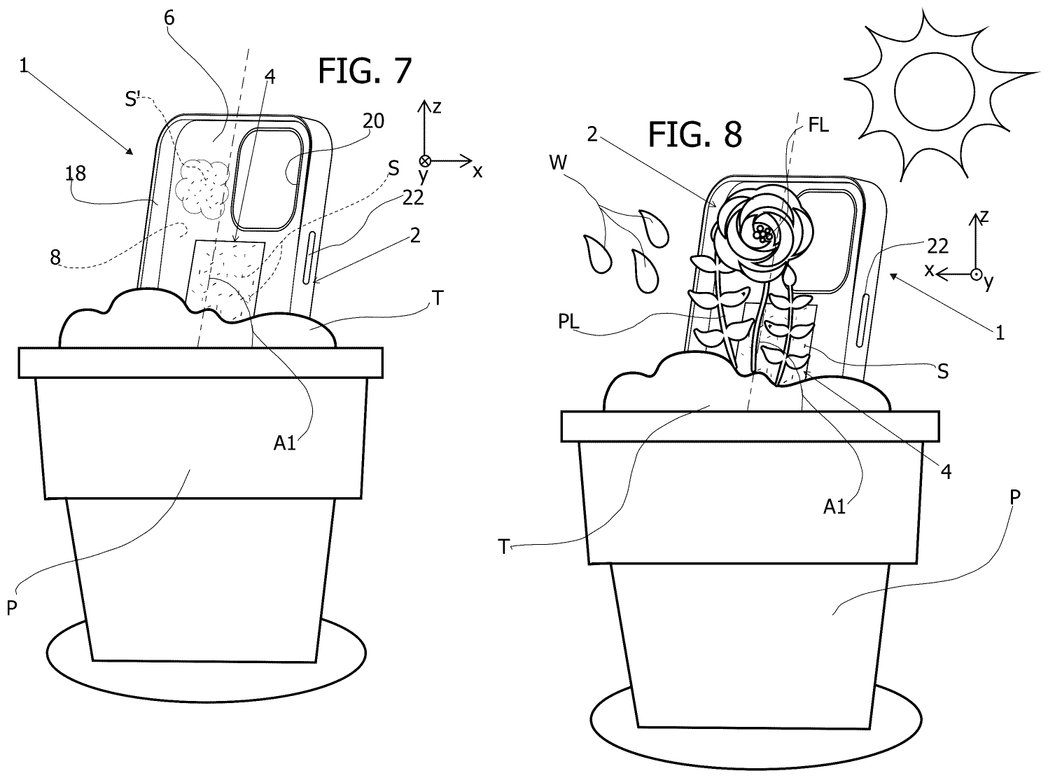

The case 1—and, generally speaking, a plantable device according to the invention—may be used as a normal protective case for the mobile telephone device D or for a mobile computer. The presence of the device D does not interfere with the seeds S (and S′, if present) or with the material of the device. On the contrary, the device D even protects the covering layer 6 from exposure to moisture, thereby contrasting an early dissolution thereof. Referring to FIGS. 7 and 8, when the case 1—and, generally speaking, a plantable device according to the invention—reaches the end of its service life, it can be planted in a layer of soil or topsoil T, in the open ground or in a pot P, while preferably remaining partially exposed. The addition of water W to water the case 1 and the soil or topsoil T causes a rapid dissolution of the covering layer 6, so that the seeds S are released into the soil or topsoil T.

Preferably, the case 1 is planted at an angle of inclination to the horizontal between 50° and 70°, as shown in FIG. 7 and FIG. 8. The angle of inclination, denoted by the reference A1, is comprised between a horizontal plane xy (see the orthogonal Cartesian triad x-y-z- in the FIGS. 7 and 8) and a tangent line to the outer surface 10 (or to the plane of the same surface 10, if the latter is flat).

The inner surface 12 is therefore exposed to the sky, so as to receive the water W directly, thereby favouring the decomposition of the water-soluble covering layer 6, the release and the growth of the seeds arranged in the housing 4. The case 1, therefore, acts as a guide during the germination and the growth of the seeds.

It will be appreciated that, in comparison with the known solution which has been mentioned at the beginning of the present description, the problem of the seeds S being constrained by the material of the device body 2, and of the consequent poor or absent germination, is eliminated, because the dissolution of layer 6 exposes the housing 4 without needing to wait for the degradation (composting) of the material of the device body 2.

If also the seeds S′ are present, they may undergo a germination process not unlike the process in the known solutions, but this is not a problem because the seeds arranged in the housing 4 are present in an amount which is more than sufficient to colonize the layer of soil or topsoil T with one or more plant varieties, including plants PL and/or flowers FL. In the worst case, the seeds of the plurality S′ will germinate later, when the material of the body 2 dissolves. In any case, the seeds of the plurality S′—irrespective of the germination thereof—may form characterizing decorative elements in the device body 2.

If the body 2 is made of non-compostable and non-biodegradable material, it is anyway possible to plant the case 1 into the topsoil T: the dissolution of the layer 6 releases the seeds of the plurality S exactly in the same way as for the body 2 of compostable material, and the body 2 may be used for affixing labels which identify the plant species in the pot P. As an alternative—which is valid both for the case of compostable material and for the case of non-compostable, non-biodegradable material—it is possible to completely embed the case 1 within topsoil T: in the former instance, the body 2 will dissolve in the topsoil, in the latter instance it will remain hidden therein without disturbing the growth of the plant varieties. In both cases, the seeds of the plurality S are released as soon as the moisture of topsoil T and/or the water W dissolve the layer 6.

Of course, the implementation details and the embodiments may amply vary with respect to what has been described and illustrated herein, without departing from the scope of the invention as defined by the annexed claims.

1. A plantable device for growing plant varieties, comprising
a device body;
a housing provided on the device body;
a first plurality of seeds of one or more plant varieties arranged in the housing; and
a water-soluble covering element arranged to cover said housing for retaining said plurality of seeds therein.

2. The plantable device according to claim 1, wherein said housing is recessed within said device body.

3. The plantable device according to claim 1, further comprising a second plurality of seeds of one or more plant varieties embedded in the device body outside of said housing.

4. The plantable device according to claim 1, wherein said water-soluble coating element is a foil-like covering element.

5. The plantable device according to claim 1, wherein the plantable device is a plantable cover for a computerized device including any one of a mobile telephone device or a mobile computer, a smartphone or a tablet, the device body of the cover comprising a back wall and a side wall projecting from said back wall to define an installation seat for said computerized device.

6. The plantable device according to claim 5, wherein said housing is made in said back wall and is open at an inner surface of said back wall.

7. The plantable device according to claim 6, wherein said foil-like covering element is applied to at least part or all, of the inner surface of said back wall, and covers said housing.

8. The plantable device according to claim 1, wherein said device body is made of compostable material.

9. A method for manufacturing a plantable device, comprising the steps of:
making said device body;
making said housing;
applying said first plurality of seeds at said housing;
applying said water-soluble covering element to cover said housing to retain said first plurality of seeds therein.

10. The method according to claim 9, wherein said making said device body comprises further steps of:
providing a mould including a mould cavity,
inserting said second plurality of seeds into said mould cavity,
injecting a compostable material into said mould cavity to form said device body, thereby incorporating the seeds of said first plurality into said device body.
